(19) United States
(12) Patent Application Publication
(10) Pub. No.: US 2026/0316442 A1
(43) Pub. Date: Oct. 15, 2026

(54) LOCALIZED COMPRESSION MESH FOR INDUCING COMPLIANCE IN DIRECT TO FILM PRINTING ON TEXTILE SUBSTRATES

(71) Applicant: Jacob A. Hudjohn, Redlands, CA (US)

(72) Inventor: Jacob A. Hudjohn, Redlands, CA (US)

(21) Appl. No.: 19/642,372

(22) Filed: Apr. 8, 2026

Related U.S. Application Data
(60) Provisional application No. 63/786,191, filed on Apr. 9, 2025.

(51) Int. Cl. B41F 16/00; B41F 16/02; D06P 5/24

(52) U.S. Cl. CPC B41F 16/006; B41F 16/0046; B41F 16/02; D06P 5/003

(57) ABSTRACT

A system and method for improving compliance in direct-to-film (DTF) transfer printing onto textile substrates. A thermally-resistant localized compression mesh, such as a 90% polyester/10% spandex blend or a steel mesh, is positioned between a heat press head and a DTF transfer sheet during heat pressing operations. The mesh defines an array of open regions bounded by warp and weft filaments, which spatially modulate applied pressure and temperature across the transfer sheet. Regions aligned with filaments experience increased pressure, while regions beneath open areas receive elevated thermal exposure. As a result, adhesive and ink layers on the transfer sheet penetrate variably into the textile substrate, inducing non-uniform adhesion characteristics.

### TECHNICAL FIELD

Embodiments described herein relate to direct to film heat transfer printing on textile substrates and, in particular, to systems and methods for inducing compliance in transferred graphics.

### BACKGROUND

Screen printing is a common technique for decorating textile substrates. A screen-printed graphic can be disposed onto a textile substrate by drawing a quantity of ink across a stencil-bearing mesh with a flexible blade, selectively depositing ink or pigment onto the substrate. Although screen printing can result in aesthetically pleasing and durable graphics, it requires significant setup time (limiting the economic feasibility of short runs), manual labor, and operator skill. These limitations have motivated adoption of alternative printing techniques for textile decoration, especially for on-demand printing or to fulfill short run orders.

Direct to Film (“DTF”) printing has emerged as an alternative textile decorating solution. A DTF printing process defines a heat-transferrable graphic by depositing layers of ink and adhesive powder onto a transfer sheet, which thereafter can be thermally transferred to a textile substrate through a heat press process. The technique has an effectively unlimited color palette and eliminates several labor intensive processes associated with screen printing, including screen and ink preparation and carousel setup and tear-down. Despite these advantages, however, DTF transfer printing often produces smooth, reflective, rigid, and continuous bodies of ink and adhesive across a substrate surface, resulting in a monolithic, non-breathable, and uncomfortable garment or other textile product with a design that cracks, peels, and degrades rapidly, decreasing textile lifespan and increasing the environmental impact of textile waste.

### SUMMARY

Embodiments described herein take the form of a heat press assembly for direct-to-film transfer printing that includes a lower press platen configured to support a fabric substrate, a transfer sheet having an ink and adhesive graphic layer disposed on a graphic-bearing side and positioned atop the fabric substrate, a localized compression mesh interposed between the transfer sheet and a heat press head, and a heat press head configured to interface the localized compression mesh and to apply heat and pressure through the localized compression mesh to the transfer sheet.

The localized compression mesh includes a number of warp filaments interwoven with a number of weft filaments to define an array of open regions, such that the localized compression mesh induces non-uniform spatial distribution of pressure and temperature across the transfer sheet during heat pressing. In some embodiments, the localized compression mesh may be formed from a polyester and spandex blend woven in an open mesh pattern, a metallic mesh, or other suitable materials, and may be supported by a rigid frame, embedded in an elasticated sleeve, or otherwise retained relative to the heat press head.

Some embodiments may include a configuration in which the localized compression mesh includes a first region having a first aperture size and a second region having a second aperture size different from the first aperture size. Some embodiments may include a configuration in which the open regions define hexagonal apertures, diamond-shaped apertures, or circular apertures. Some embodiments may include a configuration in which a second localized compression mesh is stacked atop the localized compression mesh at a different angular orientation.

Other embodiments take the form of a method of transferring a graphic to a substrate, the method including positioning a transfer sheet onto the substrate, interposing a mesh between a press head and the transfer sheet, engaging the press head against the mesh to apply heat and pressure through the mesh to the transfer sheet, and separating the transfer sheet from the substrate after engagement. The filaments of the mesh concentrate pressure onto first regions of the transfer sheet at positions of the filaments, and the open regions of the mesh permit direct thermal communication between the press head and second regions of the transfer sheet, such that the first regions and the second regions experience different pressure and different temperature during engagement. The graphic, after separation, exhibits spatially variable penetration into the substrate and spatially variable adhesion characteristics corresponding to the different pressure and different temperature experienced during engagement.

Some embodiments may include a configuration in which the mesh is selected based on a characteristic of the substrate. Some embodiments may include a configuration in which the separating includes a hot peel performed while the substrate is at or near pressing temperature, or a cold peel performed after the substrate cools to ambient temperature. Some embodiments may include a configuration in which the mesh is inspected for filament thinning, aperture deformation, or loss of elasticity, and may be cleaned after separating the transfer sheet from the substrate.

Other embodiments take the form of a decorated textile product including a textile substrate with a number of fibers defining an upper surface and a graphic deposition layer disposed on the upper surface, the graphic deposition layer including ink and adhesive powder bonded to the fibers and exhibiting spatially variable penetration depths into the textile substrate corresponding to regions of differential temperature and pressure experienced as a result of a mesh between a press head and the graphic deposition layer during application. In some embodiments, the graphic deposition layer may exhibit a non-uniform upper surface profile conforming to structural contours of the textile substrate.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a schematic overview of a direct-to-film (DTF) transfer printing system, that can leverage a localized compression mesh as described herein to induce compliance in transferred graphics.

FIG. 2A depicts a detail view A-A of FIG. 1 of an example woven fabric textile substrate with a graphic disposed thereon.

FIG. 2B depicts a cross-section along line B-B of FIG. 2A, showing an example screen printing layer.

FIG. 2C depicts a cross-section along line B-B of FIG. 2A, showing an example direct to film printing layer.

FIG. 3A depicts a detail view A-A of FIG. 1 of an alternative example knit fabric textile substrate with a graphic disposed thereon.

FIG. 3B depicts a cross-section along line C-C of FIG. 3A, showing an example screen printing layer.

FIG. 3C depicts a cross-section along line C-C of FIG. 3A, showing an example direct to film printing layer.

FIG. 4 depicts an example cross-section of a knit fabric, such as shown in FIG. 3C, depicting cracking of a direct to film printed graphic.

FIG. 5 depicts an example open mesh to facilitate localized compression of a direct to film transfer, as described herein.

FIG. 6 depicts an example heat press assembly including a localized compression mesh, as described herein.

FIG. 7A depicts a cross section of a woven fabric substrate in a heat press, in which a localized compression mesh, taken along line D-D of FIG. 5, introduces differential temperature within a transfer film.

FIG. 7B depicts a cross section of a woven fabric substrate in a heat press, in which a localized compression mesh, taken along line D-D of FIG. 5, introduces differential pressure within a transfer film.

FIG. 7C depicts a cross section of a direct to film graphic bonded to fibers of a woven fabric substrate.

FIG. 8 depicts an example cross-section of a woven fabric substrate, leveraging compliance induced by pressing with a localized compression mesh, as described herein.

FIG. 9 depicts an example assembly diagram of a localized compression mesh fitment to a head of a heat press.

FIG. 10 depicts another example assembly diagram of a localized compression mesh frame that may be used within a heat press.

FIG. 11 depicts another example assembly diagram of a localized compression mesh attachment to a heat press head.

FIG. 12 is a flow chart depicting operations of a method of operating a heat press.

FIG. 13 is a flow chart depicting operations of a method of operating a heat press as described herein.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems and methods for direct to film (“DTF”) transfer printing onto textile substrates that introduce flexibility and compliance of deposited graphics layers. Specifically, embodiments described herein relate to methods for applying localized pressure during heat pressing with a thermally-resistant open woven mesh (herein, a “localized compression mesh”). An example material for a local compression mesh may be a polyester and elastane (e.g., Spandex) blend in a ratio of approximately 90/10 (e.g., 90% poly, 10% Spandex) woven in an open mesh, with roughly 0.5 mm to 2.5 mm square openings defined between warps and wefts thereof. Although many embodiments are described herein with respect to a woven localized compression mesh, it may be appreciated that in some applications, a knit mesh may be likewise suitable. Similarly, although many embodiments described herein with warps and wefts evenly distributed to define square openings, it may be appreciated that this is not required; in some embodiments, rectangular openings and/or smaller or larger openings may be suitable.

In embodiments described herein, a section of localized compression mesh can interpose a DTF transfer sheet (placed over a fabric substrate) and a press head. Introduction of the localized compression mesh interrupts the uniformity of applied temperature and pressure experienced by conventional DTF heat pressing methods, transferring heat and pressure differently to different local sections of a transfer sheet. These different temperatures and pressures in turn locally change adhesion characteristics of adhesive powders applied to a DTF sheet. These localized areas may, in turn, experience different cooling rates which may further contribute to different adhesion characteristics in different locations.

In this manner, the spatially varying temperature and pressure experienced by a DTF transfer sheet (placed below a localized compression mesh as described herein during heat pressing) cools with an introduced compliance that exhibits improved comfort (for worn fabrics) and improved flexibility, movement, and resilience against cracking, thereby increasing a textile product's usable life. More simply, localized compression meshes and associated heat pressing methods as described herein reduce fabric waste and improve DTF print quality and durability.

Further to the foregoing, portions of a transfer sheet below an open portion of a localized compression mesh as described herein may be in different thermal communication with a heat press head during heat press operations than portions of the same transfer sheet below a warp or weft thread of the localized compression mesh. Similarly, portions of the transfer sheet below open portions of the localized compression mesh experience different pressure transfer from the heat press head than portions of the transfer sheet below a warp or weft thread of the localized compression mesh. These different portions of a transfer sheet may experience different heat transfer rates and/or different pressure, and, in turn, different cooling rates which, in turn, can result in local changes to adhesion characteristics interrupting the uniformity necessarily resulting from conventional heat pressing operations.

Depending on material(s) of a transfer sheet (and/or ink layers, adhesive powders, and so on), thickness of the transfer sheet, and/or temperature and pressure applied, transfer sheet regions below open portions of the localized compression mesh may experience greater or lower initial or sustained temperature during a pressing operation in comparison to regions of the same sheet below warp or weft portions of the same sheet. In this manner, a localized compression mesh as described herein introduces localized changes in thermal transfer and pressure transfer in comparison to conventional DTF transfer operations that results in a monolithic cohesion of deposited material.

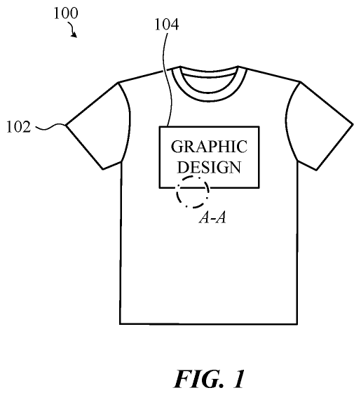

These foregoing and other embodiments are discussed below with reference to FIGS. 1-13. However, those skilled in the art will readily appreciate that the detailed description given herein with respect to these figures is for explanation only and should not be construed as limiting.

FIG. 1 depicts a schematic view of a decorated fabric substrate 100. The decorated fabric substrate 100 includes a fabric substrate 102, which may be composed of a woven or knit textile material, and a graphic 104 disposed onto a surface thereof. The graphic 104 may be applied onto the fabric substrate 102 through DTF transfer printing.

It may be appreciated that a garment such as shown in FIG. 1 is merely one example of a fabric substrate as described herein. In other cases, other fabric substrates may be used (e.g., bags, accessories, wood, metal, and so on).

In some embodiments, the decorated fabric substrate 100 may be a woven fabric substate, whereas in others, it may be a knit fabric substrate. In other cases, the decorated fabric substrate 100 may be an organic or synthetic material such as leather or vinyl. Many different textile or fabric types are possible. For simplicity of illustration and description, the embodiments that follow reference woven and knit fabrics, but it may be appreciated that these examples are not limiting.

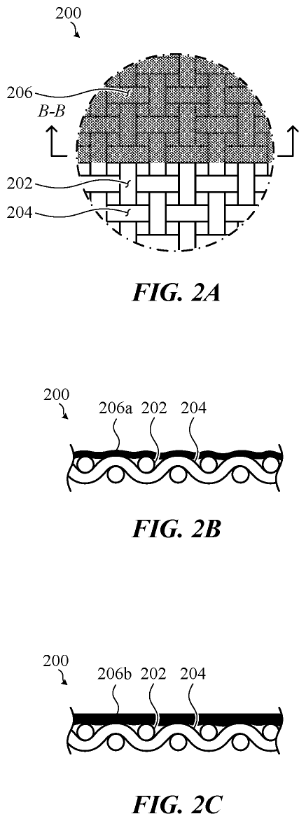

FIGS. 2A-2C depict detailed views illustrating cross-sectional differences of graphic deposition layers formed on woven textile substrates, specifically contrasting screen printing and direct-to-film transfer printing.

FIG. 2A depicts a detailed view 200 of a woven fabric substrate, such as the fabric substrate 102 introduced in FIG. 1, comprising a number of warp threads 202 interwoven perpendicularly with a number of weft threads 204. A graphic deposition layer 206 is shown disposed onto an upper portion of the woven fabric substrate.

FIG. 2B depicts a cross-sectional view taken along section line B-B of FIG. 2A, illustrating an example screen printed graphic deposition layer 206a. The screen printed graphic deposition layer 206a exhibits uneven distribution across and within the fabric substrate defined by warp threads 202 and weft threads 204, which may result from manual drawing of ink layers through one or more stencils. More specifically, in conventional screen printing, a manually drawn squeegee blade applies localized pressure as the blade is drawn across a stencil. Consequently, the screen printed graphic deposition layer 206a penetrates variably into the substrate, exhibiting different localized adhesion characteristics, a textured, irregular upper surface, and varying ink depth. These local variations of screen printing result in a flexible and comfortable worn product. However, screen printing operations require significant operator skill, and require significant setup and tear-down time to change over between different stencil and ink combinations.

By contrast, FIG. 2C depicts a cross-sectional view taken along the same section line B-B of FIG. 2A, illustrating an example direct-to-film transferred graphic deposition layer 206b formed by conventional direct-to-film printing. The direct-to-film transferred graphic deposition layer 206b is deposited onto the woven substrate comprising warp threads 202 and weft threads 204, and is thermally bonded thereto by a heat press head having an inert (e.g., non-stick) surface, such as a Teflon or parchment paper surface.

Although a DTF transfer printing operation can be performed quickly (in comparison to screen printing) and with limited operator skill, the direct-to-film transferred graphic deposition layer 206b exhibits a substantially uniform thickness and a smooth, monolithic upper surface. As may be appreciated by a person of skill in the art, the uniform and flat surface results from the uniform temperature and uniform pressure applied across the entirety of the transfer film during heat pressing. This uniform application of heat and pressure inhibits penetration into interstices defined by warp threads 202 and weft threads 204, limiting adhesion to primarily surface bonding and thus reducing flexibility and compliance in comparison to the screen printed graphic deposition layer 206a illustrated in FIG. 2B.

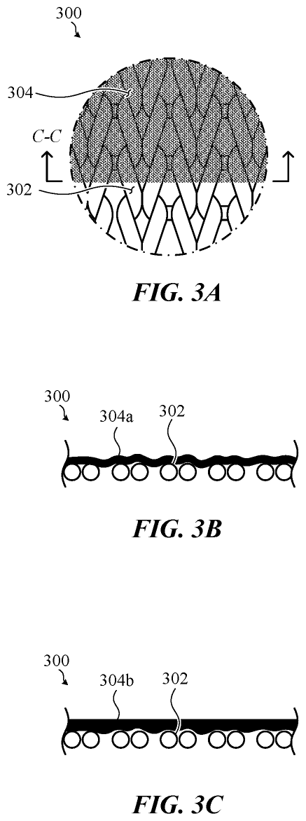

FIGS. 3A-3C depict detailed views illustrating cross-sectional differences of graphic deposition layers formed on knitted textile substrates, specifically contrasting screen printing and direct-to-film transfer printing, exhibiting analogous issues as previously illustrated in FIGS. 2A-2C for woven fabrics.

FIG. 3A depicts a detailed view 300 of a knitted fabric substrate, comprising interlocking loops of yarn defining courses and wales 302. A graphic deposition layer 304 is disposed onto an upper surface of the knitted fabric substrate.

FIG. 3B depicts a cross-sectional view taken along section line C-C of FIG. 3A, illustrating an example screen printed graphic deposition layer 304a formed on the knitted fabric substrate. As described in respect of woven fabric substrates shown in FIGS. 2A-2C, due to the manual squeegee application process of screen printing, local variations in applied pressure drive the ink layers differentially into interstitial regions between and within loops of the courses and wales 302. Consequently, the screen printed graphic deposition layer 304a exhibits varied thickness, non-uniform ink penetration into yarn fibers, and irregular surface texture, resulting in enhanced flexibility and adhesion characteristics suitable for conforming to the human body or other materials.

As with woven fabrics, knit fabrics can experience poor adhesion and performance for conventional DTF processes. In particular, FIG. 3C depicts another cross-sectional view taken along section line C-C of FIG. 3A, illustrating an example direct-to-film transferred graphic deposition layer 304b formed by conventional direct-to-film printing onto the knitted fabric substrate. Similar to the woven example previously discussed, a heat press head having a non-stick surface, applies uniform temperature and pressure to transfer the graphic deposition layer 304b to the underlying substrate. This uniform heat pressing results in the direct-to-film transferred graphic deposition layer 304b having a substantially uniform thickness, smooth and flat upper surface, and limited penetration into the knitted structure defined by the courses and wales 302. Consequently, the direct-to-film transferred graphic deposition layer 304b exhibits reduced flexibility and compliance, leading to rigidity and vulnerability to cracking and peeling during use.

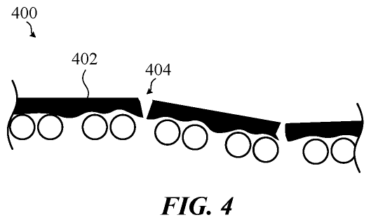

For example, FIG. 4 depicts a cross-sectional detail view 400 of a knitted fabric substrate (see, e.g., FIG. 3C) onto which a conventional direct-to-film transferred graphic deposition layer 402 has been disposed, illustrating typical degradation resulting from the inherent rigidity of the direct-to-film transferred graphic deposition layer 402. Specifically, FIG. 4 shows a representative crack 404 formed within the direct-to-film transferred graphic deposition layer 402 as a result of bending, flexing, or repeated movement associated with normal wear and use. The uniformity, rigidity, and shallow surface adhesion characteristics of the direct-to-film transferred graphic deposition layer 402 cause an inability to adequately conform to and move with the fabric substrate and the wearer, resulting in the illustrated structural failure.

These foregoing embodiments depicted in FIGS. 2A-4 and various alternatives thereof and variations thereto are presented, generally, for purposes of explanation, and to facilitate an understanding of various structural disadvantages associated with conventional DTF printing, such as described herein.

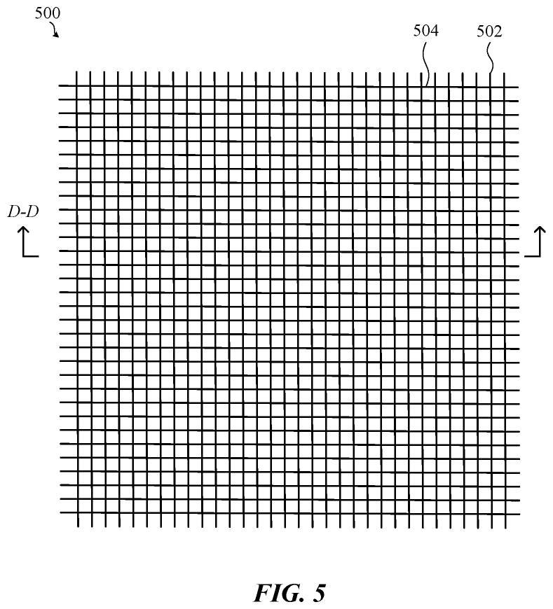

To address the cost and time inefficiencies of screen printing and to address the durability, comfort and quality deficiencies of conventional DTF printing, embodiments described herein introduce localized compression meshes into heat pressing operations. In particular, FIG. 5 depicts a schematic view of a localized compression mesh 500 suitable for use in direct-to-film transfer printing processes as described herein. The localized compression mesh 500 comprises a number of warp filaments 502 interwoven perpendicularly with a number of weft filaments 504 to form a structured mesh. The arrangement of warp filaments and weft filaments define an array of open regions between individual filaments, which may be square or may take non rectilinear or non-square shapes. In one embodiment, dimensions of these open square regions measure approximately 1.2 mm by 1.2 mm. It will be appreciated, however, that these open square regions may exhibit dimensions ranging from approximately 0.5 mm by 0.5 mm to approximately 3 mm by 3 mm in other embodiments.

It may be appreciated that size of these open regions can influence differential application of pressure and temperature during a direct-to-film heat transfer operation. The structure and filament positioning of the localized compression mesh 500 creates localized variations in applied pressure and thermal transfer characteristics. Specifically, during heat pressing, warp filaments 502 and weft filaments 504 apply concentrated pressure onto corresponding regions of a transfer sheet, thereby causing increased localized adhesion and deeper penetration of ink and adhesive powder into textile substrates positioned beneath these filaments. Conversely, portions of the transfer sheet beneath the open square regions of the mesh experience relatively lower pressure but enhanced heat exposure due to increased direct thermal communication with the heated press head surface. This combination of concentrated pressure beneath filaments and elevated thermal exposure within open mesh areas results in non-uniform temperature and pressure distributions across the transfer sheet.

More broadly, it may be appreciated that the localized compression mesh of many embodiments is selected at least in part based on its open form. In particular, if the open regions of the mesh were significantly smaller (resulting in a more closed mesh), the mesh structure would apply more uniform pressure and temperature, approximating conditions typical of conventional direct-to-film printing, thereby limiting flexibility and compliance. Conversely, if the open regions were larger, the distribution of pressure and temperature would tend toward greater spatial uniformity due to a reduction in localized pressure concentration and more uniform thermal communication with the heat source, similarly reducing compliance and flexibility. In this manner, the selected sizing and structure of localized compression mesh 500—which may vary from embodiment to embodiment—provides an effective intermediate balance to maximize differential pressure and thermal characteristics during transfer printing, resulting in improved compliance, flexibility, and durability of the transferred graphics.

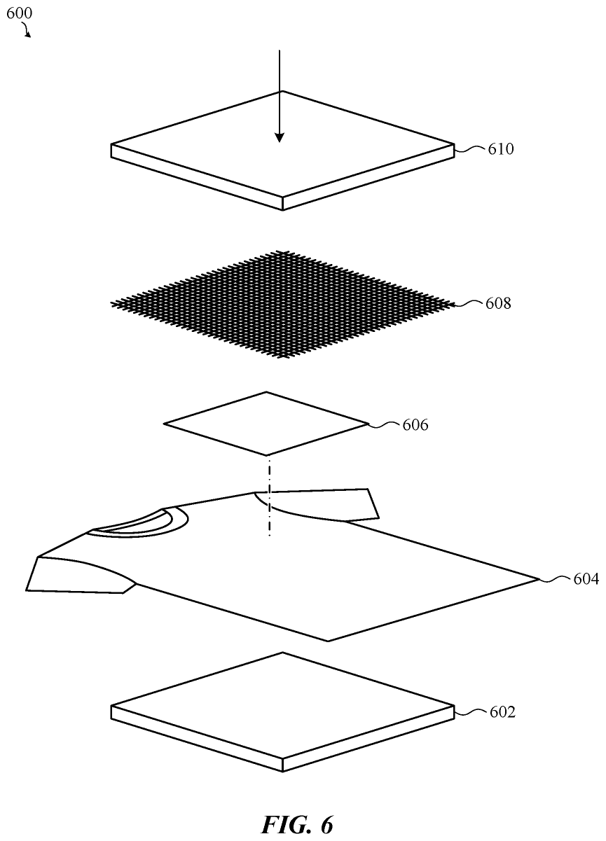

FIG. 6 depicts an exploded schematic view of a heat press assembly 600 configured for direct-to-film transfer printing using a localized compression mesh as described herein. The heat press assembly 600 includes a lower press platen 602 upon which a fabric substrate 604 is positioned. A transfer sheet 606, having an ink and adhesive graphic layer disposed thereon, is placed directly atop the fabric substrate 604, oriented such that the graphic layer contacts the upper surface of the fabric substrate 604. Positioned above the transfer sheet 606 is a localized compression mesh 608, similar in structure and function to the mesh described with reference to FIG. 5. A heat press head 610 is located above the localized compression mesh 608, configured for vertical movement downward (indicated by an arrow) to engage the mesh and compress the transfer sheet 606 against the fabric substrate 604 and the lower press platen 602.

In operation, the heat press head 610 moves downward, engaging the localized compression mesh 608, and thereby applying pressure and heat through the mesh onto the transfer sheet 606. The localized compression mesh 608 induces non-uniform spatial distribution of pressure and temperature across the surface of the transfer sheet 606. Specifically, the mesh filaments concentrate applied pressure onto localized areas of the transfer sheet 606, enhancing penetration and adhesion of ink and adhesive powder into the fabric substrate 604 beneath the mesh filaments, whereas open areas defined by the mesh allow direct heat transfer without direct filament pressure. As described herein, this arrangement modifies adhesion characteristics of the ink and adhesive, resulting in improved compliance, flexibility, and durability of the transferred graphic on the fabric substrate 604.

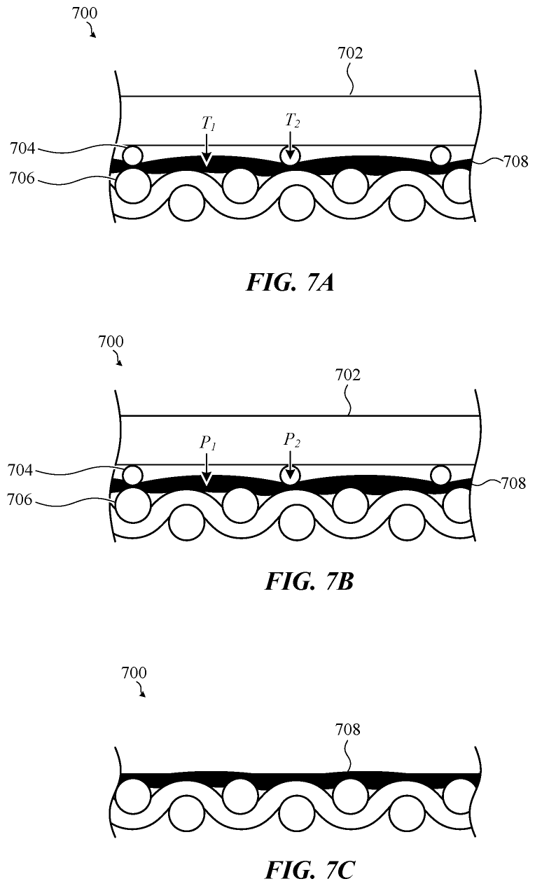

FIGS. 7A-7C depict detailed schematic cross-sectional views illustrating effects of localized compression mesh utilization within a heat press assembly during direct-to-film transfer printing onto a fabric substrate.

FIG. 7A illustrates a detailed view 700 of a heat press head 702 engaging a localized compression mesh 704 placed atop a transfer sheet 706 during heat pressing onto a fabric substrate. The presence of the localized compression mesh 704 results in spatially non-uniform temperature distribution across the transfer sheet 706, indicated as T₁ and T₂. Specifically, regions beneath open areas of the mesh (indicated as T₂) experience relatively elevated thermal exposure due to closer direct thermal communication with the heat press head 702. Conversely, regions directly beneath the filaments of the localized compression mesh 704 (indicated as T₁) exhibit reduced heat transfer efficiency due to the insulating effect provided by the mesh filaments, despite experiencing greater pressure.

FIG. 7B illustrates the same detailed view 700, specifically emphasizing differential pressure distribution (indicated as P₁ and P₂) resulting from the localized compression mesh 704. Regions of the transfer sheet 706 directly beneath mesh filaments (indicated as P₁) experience substantially increased pressure, causing enhanced penetration and adhesion of ink and adhesive into the underlying fabric substrate fibers. Regions of the transfer sheet 706 beneath open mesh areas (experiencing pressure P₂) receive reduced direct mechanical compression, resulting in comparatively lower local pressure but higher relative heat exposure as previously described.

FIG. 7C illustrates the result of the combined non-uniform temperature and pressure distribution after the heat press head 702 and localized compression mesh 704 have been removed. The transfer sheet 706 has deposited a graphic deposition layer 708 onto the fabric substrate, characterized by spatially variable penetration and adhesion characteristics due to the locally varying heat and pressure conditions described above. As a consequence, the graphic deposition layer 708 exhibits improved flexibility, compliance, and durability in comparison to conventional direct-to-film printing, effectively conforming to and integrating with the structural contours of the fabric substrate.

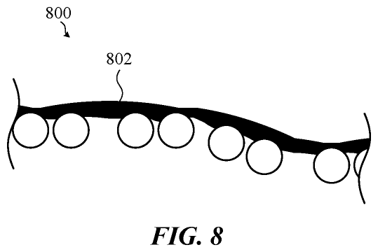

FIG. 8 depicts a schematic cross-sectional view 800 of a graphic deposition layer 802 disposed onto a fabric substrate, resulting from direct-to-film transfer printing leveraging a localized compression mesh as described herein. The graphic deposition layer 802 exhibits spatially variable penetration depths into the fabric substrate, corresponding to regions of differential temperature and pressure application induced by the localized compression mesh during the heat press operation. The graphic deposition layer 802 further exhibits a non-uniform upper surface profile conforming more naturally to the structural contours of the underlying fabric substrate. As a consequence, the graphic deposition layer 802 has improved flexibility, compliance, and resistance to cracking or peeling during repeated use, achieving characteristics similar to those typically associated with screen printing methods, while preserving the color versatility and production advantages of direct-to-film printing.

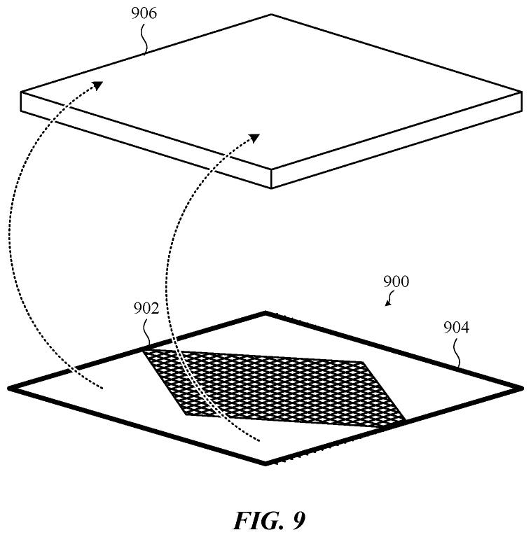

FIG. 9 depicts an example localized compression mesh sleeve 900, which may be positioned onto a press head 906 of a heat press. The localized compression mesh sleeve 900 includes a localized compression mesh 902 coupled to a surrounding flexible material 904. The localized compression mesh 902 may be constructed from a thermally-resistant, pressure-tolerant material, including but not limited to a 90% polyester and 10% spandex blend, or alternatively a durable metal mesh, such as steel, or another material configured to define an open mesh pattern with approximately 1 mm by 1 mm openings (which may vary from embodiment to embodiment).

The flexible material 904 surrounding the localized compression mesh 902 may be formed from an elastic fabric such as spandex, Lycra, or other stretchable textiles. For some embodiments, the localized compression mesh 902 may define a central diamond shape, an oval shape, or another aperture geometry suitable for altering thermal and pressure distribution during heat pressing operations. The flexible material 904 may further define wings or flaps that partially or entirely overlap one another, thereby forming a sleeve or pocket structure through which the press head 906 may be inserted. When affixed or tensioned over the press head 906, the localized compression mesh 902 is held in a position to interpose between the press head 906 and a transfer sheet placed atop a fabric substrate, enabling selective alteration of thermal and mechanical transfer characteristics during DTF heat pressing operations.

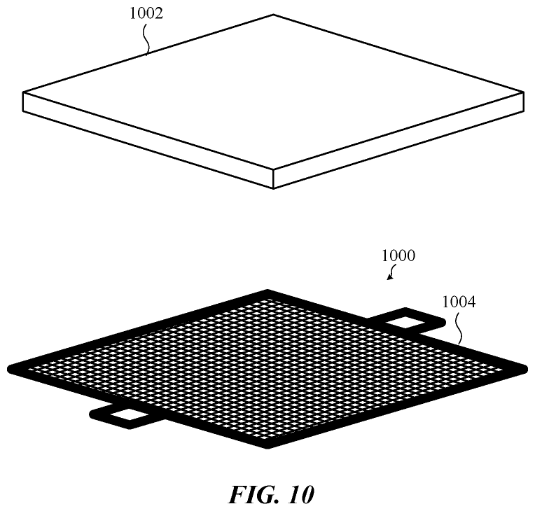

FIG. 10 depicts an example localized compression mesh frame 1000 configured for use with a heat press head 1002. The localized compression mesh frame 1000 includes a rigid frame 1004 surrounding and supporting a localized compression mesh. The rigid frame 1004 may be constructed from wood, metal, plastic, acrylic, or any other material of sufficient rigidity to maintain the planar structure and dimensional stability of the mesh during heat pressing operations.

The localized compression mesh supported by the rigid frame 1004 defines an open mesh pattern, which may include approximately 1 mm by 1 mm square openings, and may be fabricated from a flexible yet durable material such as a 90/10 polyester/spandex textile or, for some embodiments, a metallic mesh such as steel. The rigid frame 1004 includes integrated handles or tabs to facilitate manual placement and removal of the localized compression mesh frame 1000 relative to the heat press head 1002. During use, the localized compression mesh frame 1000 may be positioned between the heat press head 1002 and a transfer sheet during a heat press operation to induce spatial variations in temperature and pressure across the surface of the transfer.

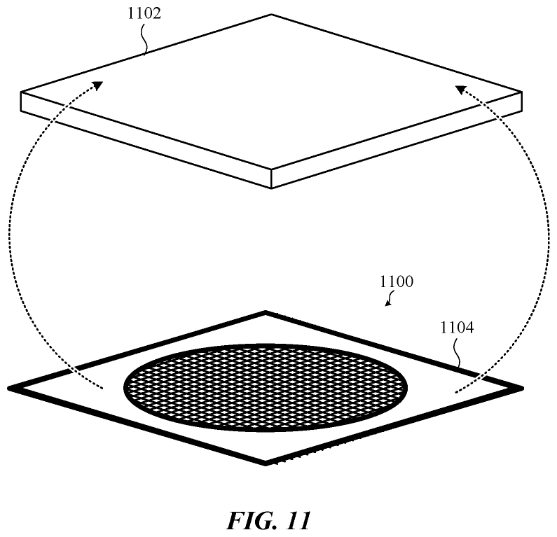

FIG. 11 depicts an example localized compression mesh sleeve 1100 configured to receive a press head 1102 of a heat press. The localized compression mesh sleeve 1100 includes a localized compression mesh 1104 defined within an elasticated portion forming a planar sleeve structure. The localized compression mesh 1104 defines a circular aperture formed from an open mesh material. The open mesh may be a 90/10 polyester/spandex blend or, for some embodiments, a steel mesh or another thermally and mechanically stable material configured with openings of approximately 1 mm by 1 mm.

The elasticated portion of the localized compression mesh sleeve 1100 may be formed from a stretchable textile, such as spandex, and may define overlapping or inter-fitting portions to receive and retain the press head 1102. When tensioned over the press head 1102, the circular localized compression mesh 1104 may be positioned in thermal and mechanical contact with a DTF transfer sheet during pressing, interrupting uniformity of heat and pressure across the pressing surface. The shape and positioning of the circular mesh region within the sleeve facilitates selective localized compression during the heat press operation.

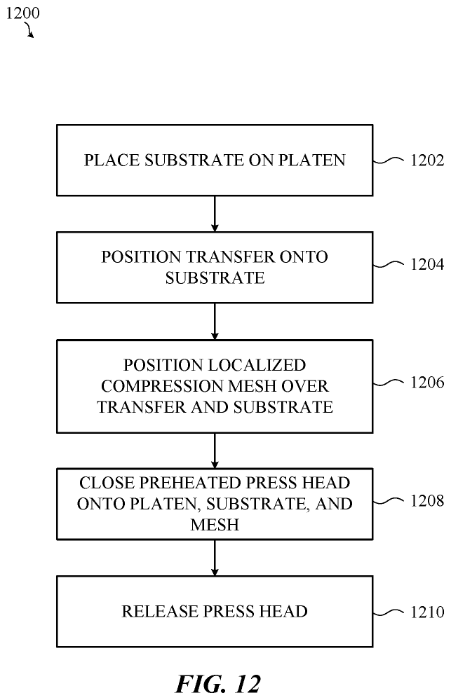

FIG. 12 depicts a flow diagram of a method 1200 for performing a heat press operation incorporating a localized compression mesh to transfer a direct-to-film (DTF) graphic onto a textile substrate.

At operation 1202, a substrate is placed on a platen. The platen may be a lower heated or unheated surface of a heat press system, and the substrate may be a textile material such as a cotton, polyester, or blended fabric layer prepared to receive a transfer.

At operation 1204, a transfer is positioned onto the substrate. The transfer may include a DTF film having a graphic defined by one or more layers of pigmented ink and adhesive powder arranged according to a predetermined design. The graphic-bearing side of the transfer may be placed in contact with the upper surface of the textile substrate.

At operation 1206, a localized compression mesh is positioned over the transfer and substrate. The localized compression mesh may be unsupported, or supported within a rigid frame or embedded in an elasticated sleeve, and may include an open mesh structure composed of flexible or metallic material. The mesh may be arranged such that it overlays the transfer and contacts the upper surface of the transfer sheet.

At operation 1208, a preheated press head is closed onto the platen, substrate, and mesh. The press head, which may include a non-stick surface, applies heat and pressure through the localized compression mesh to the transfer, inducing differential thermal and mechanical interaction between the ink/adhesive layers and the textile substrate. Pressure is concentrated along filaments of the mesh while open regions of the mesh permit relatively higher heat transfer.

At operation 1210, the press head is released. The press head is withdrawn from the localized compression mesh, transfer, and substrate, completing the heat press cycle. The result is a transferred graphic exhibiting spatially variable depth and adhesion characteristics induced by the differential heat and pressure imparted by the mesh structure during pressing.

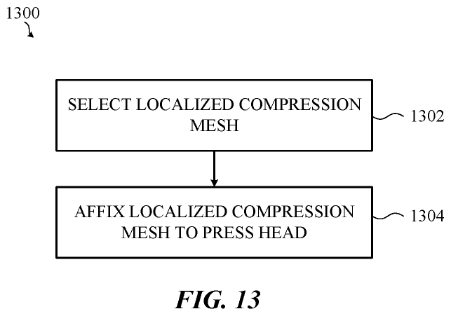

FIG. 13 depicts a flow diagram of a method 1300 for preparing a heat press assembly configured to introduce localized compression through a mesh during a direct-to-film (DTF) transfer operation.

At operation 1302, a localized compression mesh is selected. The localized compression mesh may be selected based on material, mesh aperture geometry, mesh density, or structural configuration. In some embodiments, the selected mesh may be formed from a 90% polyester/10% spandex blend configured in an open weave pattern with openings measuring approximately 1 mm by 1 mm. In other embodiments, the localized compression mesh may be formed from a metallic mesh, such as steel, or from another heat-resistant and pressure-tolerant material suitable for maintaining mesh structure during heat press operations.

At operation 1304, the localized compression mesh is affixed to a press head. Affixation may be achieved using a mesh sleeve structure that stretches around the perimeter of the press head, a rigid frame that positions the mesh beneath the press head, or other suitable fastening or retaining mechanisms. The affixed mesh may thereafter remain in thermal and mechanical contact with the press head surface during transfer operations, facilitating localized modulation of heat and pressure during engagement with a DTF transfer sheet and a textile substrate.

In some embodiments, the localized compression mesh may be formed from materials other than a polyester and spandex blend or a steel mesh. For example, a localized compression mesh may be formed from fiberglass mesh, aramid fiber mesh (e.g., Kevlar or Nomex), silicone-coated fiberglass mesh, bronze mesh, copper mesh, nickel-chromium alloy mesh, titanium mesh, ceramic-coated polymer mesh, polytetrafluoroethylene (herein, “PTFE”) mesh, or any other material or combination of materials configured to withstand repeated exposure to temperatures and pressures encountered during heat press operations. In some embodiments, a mesh material may be selected based at least in part on thermal conductivity, such that filaments of the mesh conduct heat from the press head to the transfer sheet at a rate different from the rate of heat transfer through open regions of the mesh. In other embodiments, a mesh material may be selected based at least in part on elasticity, compressibility, coefficient of friction, chemical inertness, or resistance to thermal degradation over repeated press cycles. For example, a mesh formed from an aramid fiber may offer greater thermal stability and dimensional retention at elevated temperatures in comparison to a polyester and spandex blend, although this is not required of all embodiments. Similarly, a metallic mesh (e.g., bronze, copper, or stainless steel) may offer greater rigidity and more aggressive pressure concentration at filament contact points, potentially increasing penetration depth of ink and adhesive into a textile substrate. It may be appreciated that different mesh materials may impart different differential pressure and temperature characteristics to a transfer sheet, and selection of a mesh material may be informed at least in part by characteristics of the textile substrate, the ink and adhesive formulation, and the desired compliance and durability characteristics of the finished product.

In further embodiments, a localized compression mesh may define aperture geometries other than square or rectangular openings. For example, a localized compression mesh may define hexagonal apertures, diamond-shaped apertures, triangular apertures, circular or elliptical apertures, or irregular or randomized aperture patterns. In some embodiments, hexagonal apertures may distribute pressure and temperature more uniformly across a greater number of angular orientations in comparison to square apertures, potentially reducing directional bias in compliance characteristics of a transferred graphic.

In other embodiments, diamond-shaped or triangular apertures may concentrate pressure along different angular axes, potentially influencing the directionality of compliance and flexibility imparted to the graphic deposition layer. In yet other embodiments, circular apertures may produce radially symmetric differential pressure and temperature distributions within each aperture region, resulting in more isotropic compliance characteristics.

It may be appreciated that aperture geometry may also influence the spatial frequency of differential pressure and temperature application; for example, a mesh with smaller, more closely spaced hexagonal apertures may produce a finer-grained compliance pattern in comparison to a mesh with larger square apertures. Selection of aperture geometry may be informed at least in part by the intended use of the decorated textile product, the type of textile substrate, and the desired visual and tactile characteristics of the transferred graphic, although this is not required of all embodiments.

In some embodiments, the density of a localized compression mesh (e.g., a number of openings per linear centimeter or per linear inch) and the gauge or diameter of individual filaments thereof may be selected to influence the resulting differential pressure and temperature distribution during a heat press operation. A mesh with thicker filaments may concentrate greater pressure onto narrower contact regions of a transfer sheet, potentially driving ink and adhesive more aggressively into a textile substrate at filament contact points, whereas a mesh with thinner filaments may distribute pressure more gently across a greater number of contact points. Similarly, a mesh with higher density (e.g., more openings per unit length) may produce a finer spatial pattern of differential pressure and temperature, resulting in a more granular compliance texture across the graphic deposition layer, whereas a lower density mesh may produce broader regions of differentiated adhesion characteristics.

In further embodiments, filament gauge and mesh density may be selected in combination; for example, a mesh with fine-gauge filaments at high density may produce subtle compliance modulation suitable for lightweight performance knit fabrics, while a mesh with thicker filaments at lower density may produce more pronounced compliance modulation suitable for heavier fabrics, such as canvas or denim. It may be appreciated that filament cross-sectional shape (e.g., round, flat, or ovoid) may also influence the contact area and pressure distribution at each filament-to-transfer-sheet contact point, although this is not required.

In some embodiments, a localized compression mesh may include two or more distinct regions having different aperture sizes, filament gauges, weave densities, or material compositions. For example, a central region of the mesh corresponding to a central portion of a graphic may define larger apertures or a lower weave density to induce greater compliance and flexibility in the central portion of the transferred graphic, whereas peripheral regions of the same mesh may define smaller apertures or higher weave density to promote stronger adhesion and edge durability at the periphery of the graphic.

In other embodiments, a localized compression mesh may include a first region formed from a first material (e.g., a polyester and spandex blend) and a second region formed from a second material (e.g., a metallic mesh), such that different regions of the mesh impart different thermal and mechanical transfer characteristics to corresponding regions of a transfer sheet. In further embodiments, zoned mesh configurations may be selected based at least in part on the geometry or content of the graphic to be transferred; for example, regions of a graphic containing fine detail or text may benefit from a different mesh density in comparison to regions containing large fields of solid color. It may be appreciated that zoned or regionally varied mesh configurations may be produced by weaving, welding, bonding, or otherwise joining sections of mesh having different characteristics into a single composite mesh structure, although other fabrication techniques may be suitable.

In some embodiments, a localized compression mesh as described herein may be reused across a number of heat press cycles before replacement. The number of press cycles a given mesh may withstand before exhibiting degradation may depend at least in part on the material composition of the mesh, the temperature and pressure applied during each press cycle, the duration of each press cycle, and the chemical composition of inks and adhesive powders used in the DTF transfer process.

In some embodiments, a polyester and spandex blend mesh may withstand a limited number of press cycles before exhibiting measurable degradation in elasticity, dimensional stability, or thermal resistance. In other embodiments, a metallic mesh (e.g., stainless steel or bronze) may withstand a substantially greater number of press cycles due to greater thermal and mechanical durability.

In further embodiments, an operator or automated system may inspect a localized compression mesh periodically for signs of wear, including but not limited to: filament thinning; aperture deformation or enlargement; loss of elasticity or tension; discoloration indicating thermal degradation; accumulation of adhesive or ink residue; and so on.

In some embodiments, the localized compression mesh may be cleaned between press cycles using mechanical agitation, solvent application, ultrasonic cleaning, or other suitable cleaning methods to extend the operational life of the mesh. Replacement criteria may include a threshold number of press cycles, a visual or tactile assessment of mesh condition, or a measurable change in compliance or adhesion characteristics of transferred graphics produced with the mesh.

In some embodiments, two or more layers of localized compression mesh may be stacked or layered between a heat press head and a transfer sheet to achieve finer or more complex patterns of differential pressure and temperature distribution. For example, a first mesh layer having a first aperture size and a first filament gauge may be positioned atop a second mesh layer having a second aperture size and a second filament gauge, such that the composite structure produces a superimposed pattern of pressure and temperature variation across the transfer sheet.

In some embodiments, the relative angular orientation of stacked mesh layers may be varied to influence the resulting spatial pattern; for example, rotating a second mesh layer by approximately 45 degrees relative to a first mesh layer may produce a denser and more isotropic pattern of differential pressure application in comparison to two layers oriented in the same direction.

In other embodiments, stacked mesh layers may be formed from different materials; for example, a first layer formed from a polyester and spandex blend may provide a baseline of compliance modulation, while a second layer formed from a fine metallic mesh may introduce additional localized pressure concentration. It may be appreciated that the number of mesh layers, the relative orientation of those layers, and the material composition of each layer may be selected to tailor compliance, flexibility, and adhesion characteristics for a particular textile substrate, ink and adhesive formulation, and intended use, although this is not required of all embodiments.

In some embodiments, selection of a localized compression mesh may be informed at least in part by characteristics of the textile substrate onto which a graphic is to be transferred. For example, heavier weight fabric substrates (e.g., canvas, denim, or heavy cotton twill) may benefit from meshes with larger apertures and thicker filaments, as such substrates may accommodate more aggressive penetration of ink and adhesive without structural deformation of the substrate.

Conversely, lighter weight fabric substrates (e.g., performance polyester knits, jersey, or lightweight blends) may benefit from finer meshes with smaller apertures and thinner filaments to produce more subtle compliance modulation and to reduce the risk of over-penetration, substrate deformation, or visible mesh-pattern transfer to the exterior surface of the garment. In further embodiments, the stretch characteristics of the textile substrate may inform mesh selection; for example, a highly elastic substrate (e.g., a four-way stretch knit) may benefit from a mesh configuration that produces greater compliance in the graphic deposition layer to accommodate the elastic range of the substrate during wear.

In other embodiments, the surface texture of the textile substrate may influence mesh selection; for example, a substrate with a raised or textured surface (e.g., a fleece or terry cloth) may benefit from a mesh configuration that promotes deeper penetration of ink and adhesive into the textured surface structure, whereas a smooth substrate may benefit from a finer mesh configuration. It may be appreciated that substrate-specific mesh pairing may be determined through empirical testing, operator experience, or reference to a lookup table correlating substrate characteristics to recommended mesh parameters, although other approaches may be suitable.

In some embodiments, the cooling rate and peel timing following a heat press operation performed with a localized compression mesh may influence the compliance, flexibility, and adhesion characteristics of the transferred graphic. In some embodiments, a hot peel may be performed, in which the transfer sheet is separated from the textile substrate and graphic deposition layer while the assembly is still at or near pressing temperature. In other embodiments, a cold peel may be performed, in which the assembly is permitted to cool to ambient or near-ambient temperature before the transfer sheet is separated.

It may be appreciated that the differential thermal history introduced by the localized compression mesh during pressing may result in spatially variable cooling rates across the graphic deposition layer after the press head is released. Regions of the graphic deposition layer that experienced higher temperature during pressing (e.g., regions beneath open areas of the mesh) may retain heat longer than regions that experienced lower temperature (e.g., regions beneath mesh filaments), and this spatially variable cooling may further contribute to differential adhesion and compliance characteristics.

In further embodiments, the peel timing (e.g., immediate hot peel, delayed warm peel, or full cold peel) may be selected in combination with mesh characteristics and press parameters to optimize the balance between adhesion strength and flexibility of the transferred graphic. In some embodiments, a controlled cooling protocol (e.g., removal of the press head followed by a timed interval before peeling) may be employed to achieve more consistent results, although this is not required of all embodiments.

In some embodiments, compliance, flexibility, adhesion, and durability characteristics of a graphic transferred using a localized compression mesh as described herein may be evaluated through one or more quality assessment methods. For example, a wash cycle test may be performed in which a decorated textile substrate is subjected to a number of machine wash and dry cycles and inspected for cracking, peeling, fading, or delamination of the graphic deposition layer.

In other embodiments, a flex test may be performed in which a decorated textile substrate is repeatedly folded, bent, or stretched across the region of the graphic and inspected for cracking or delamination after a predetermined number of flex cycles. In further embodiments, a peel strength test may be performed by applying a measured force to an edge of the graphic deposition layer and recording the force at which the graphic separates from the textile substrate.

In yet other embodiments, visual inspection under magnification (e.g., optical microscopy or digital imaging) may be used to assess the depth and uniformity of ink and adhesive penetration into the textile substrate, the texture and surface profile of the graphic deposition layer, and the presence or absence of defects. It may be appreciated that results of such quality assessment methods may be used to iteratively refine selection of mesh parameters (e.g., aperture size, filament gauge, material composition, mesh density), press parameters (e.g., temperature, pressure, duration), and peel protocol for a given textile substrate and ink/adhesive combination, thereby enabling systematic optimization of the DTF transfer process as described herein.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A heat press assembly for direct-to-film transfer printing, comprising:
a lower press platen configured to support a fabric substrate;
a transfer sheet having an ink and adhesive graphic layer disposed on a graphic-bearing side of the transfer sheet, the transfer sheet positioned atop the fabric substrate such that the ink and adhesive graphic layer contacts an upper surface of the fabric substrate;
a localized compression mesh interposed between the transfer sheet and a heat press head, the localized compression mesh comprising a number of warp filaments interwoven with a number of weft filaments to define an array of open regions between the warp filaments and the weft filaments; and
a heat press head configured to interface the localized compression mesh and to apply heat and pressure through the localized compression mesh to the transfer sheet, the localized compression mesh inducing non-uniform spatial distribution of pressure and temperature across the transfer sheet such that regions of the transfer sheet beneath the warp filaments and the weft filaments receive a first pressure and a first temperature, and regions of the transfer sheet beneath the open regions receive a second pressure different from the first pressure and a second temperature different from the first temperature.

2. The heat press assembly of claim 1, the localized compression mesh formed from a 90% polyester and 10% spandex blend woven in an open mesh pattern.

3. The heat press assembly of claim 1, the localized compression mesh formed from a metallic mesh.

4. The heat press assembly of claim 1, the localized compression mesh supported by a rigid frame configured for manual placement between the heat press head and the transfer sheet.

5. The heat press assembly of claim 1, the localized compression mesh embedded in an elasticated sleeve configured to receive the heat press head.

6. The heat press assembly of claim 1, further comprising a second localized compression mesh stacked atop the localized compression mesh at an angular orientation different from the localized compression mesh.

7. The heat press assembly of claim 1, the localized compression mesh comprising a first region having a first aperture size and a second region having a second aperture size different from the first aperture size.

8. The heat press assembly of claim 1, the open regions defining hexagonal apertures, diamond-shaped apertures, or circular apertures.

9. A method of transferring a graphic to a substrate, the method comprising:
positioning a transfer sheet onto the substrate, the transfer sheet comprising one or more layers of pigmented ink and adhesive powder disposed on a graphic-bearing side of the transfer sheet;
interposing a mesh between a press head and the transfer sheet, the mesh defining a number of open regions separated by a number of filaments;
engaging the press head against the mesh to apply heat and pressure through the mesh to the transfer sheet, the filaments of the mesh concentrating pressure onto first regions of the transfer sheet at positions of the filaments, and the open regions of the mesh permitting direct thermal communication between the press head and second regions of the transfer sheet at positions of the open regions, such that the first regions and the second regions experience different pressure and different temperature during engagement; and
separating the transfer sheet from the substrate after engagement, the graphic exhibiting spatially variable penetration into the substrate and spatially variable adhesion characteristics corresponding to the different pressure and different temperature experienced by the first regions and the second regions during engagement.

10. The method of claim 9, further comprising selecting the mesh based on a characteristic of the substrate.

11. The method of claim 9, further comprising cleaning the mesh after separating the transfer sheet from the substrate.

12. The method of claim 9, the separating comprising a hot peel performed while the substrate is at or near pressing temperature.

13. The method of claim 9, the separating comprising a cold peel performed after the substrate cools to ambient temperature.

14. The method of claim 9, further comprising affixing the mesh to the press head using an elasticated sleeve before engaging the press head.

15. The method of claim 9, the filaments comprising warp filaments interwoven with weft filaments defining the open regions.

16. The method of claim 9, further comprising inspecting the mesh for filament thinning, aperture deformation, or loss of elasticity.

17. A decorated textile product, comprising:
a textile substrate comprising a number of fibers defining an upper surface; and
a graphic deposition layer disposed on the upper surface of the textile substrate, the graphic deposition layer comprising ink and adhesive powder bonded to the fibers of the textile substrate, the graphic deposition layer exhibiting spatially variable penetration depths into the textile substrate corresponding to regions of differential temperature and pressure experienced as a result of a rigid mesh between a press head and the graphic deposition layer during application of the graphic deposition layer.

18. The decorated textile product of claim 17, the textile substrate comprising a woven fabric substrate defined by warp threads interwoven with weft threads.

19. The decorated textile product of claim 17, the rigid mesh comprising warp filaments interwoven with weft filaments defining open regions between the warp filaments and the weft filaments.

20. The decorated textile product of claim 17, the graphic deposition layer exhibiting a non-uniform upper surface profile conforming to structural contours of the textile substrate.
